(19) United States
(12) Patent Application Publication
(10) Pub. No.: US 2022/0146460 A1
(43) Pub. Date: May 12, 2022

(54) GUIDED WAVE TESTING OF WELDS IN PIPELINES AND PLATE STRUCTURES

(71) Applicant: Southwest Research Institute, San Antonio, TX (US)

(72) Inventors: Adam Cobb, San Antonio, TX (US); Jay Fisher, Alamo Heights, TX (US)

(21) Appl. No.: 17/524,589

(22) Filed: Nov. 11, 2021

Related U.S. Application Data
(60) Provisional application No. 63/112,342, filed on Nov. 11, 2020.

(51) Int. Cl. G01N 29/24; G01N 29/04; G01N 29/265

(52) U.S. Cl. CPC G01N 29/2462; G01N 29/043; G01N 29/265; G01N 2291/2636; G01N 2291/0289; G01N 2291/044; G01N 2291/0234

(57) ABSTRACT

A method of testing for defects in welds of a structure, such as a pipeline or plate structure. One or more ultrasonic guided wave transducers are placed against a wall of the structure. The orientation of the transducer(s) is such that guided waves are directed toward a weld at an angle to the weld. The transducer(s) are used to deliver guided waves and to receive reflection signals, which are then processed to indicate if a defect is present in the weld.

### PRIORITY CLAIM

This patent application asserts the priority benefit of U.S. Provisional Patent Application No. 63/112,342, filed Nov. 11, 2020.

### TECHNICAL FIELD OF THE INVENTION

This invention relates to guided wave testing, and more specifically to guided wave testing of girth welds in pipelines and plate welds in other large structures.

### BACKGROUND OF THE INVENTION

High pressure pipelines are typically fabricated from segments of pipe that are joined in the field by girth welds. Sometimes the girth welds fail, either because of weakening from corrosion or due to residual stress created during the welding process.

Pipeline failures can be catastrophic to the pipeline operator and to the environment, so some means of non-destructive post-construction inspection is necessary. The pipes are usually installed underground, which complicates the task of performing inspections.

Although there are many inline inspection tools that have been developed to detect pipe wall thinning, these tools are generally not capable of detecting defects in girth welds. This is due to the surface geometry of the welds; the weld root extends beyond the pipe inner wall, creating an irregular surface that must be negotiated by the sensors on inspection tools. This irregular surface reduces the performance of both magnetic flux leakage tools and ultrasonic tools at the girth welds. For these reasons, conventional in-line inspection tools are primarily suitable for pipe wall inspection rather than welds.

### BRIEF DESCRIPTION OF THE DRAWINGS

FIG. 1 illustrates a conventional guided wave transducer being used to deliver guided waves along the walls of a pipeline and to receive reflection signals.

FIG. 2 illustrates the initial pulse and reflection signals from the weld, defect, and flange from the conventional system of FIG. 1.

FIG. 3 illustrates the orientation of an ultrasonic guided wave transducer for testing welds in accordance with the invention.

FIG. 4 illustrates an example of inspection results using the conventional inspection system of FIG. 1.

FIG. 5 illustrates inspection results for the same test sample as FIG. 4 but using the angled transducer of FIG. 3.

FIG. 6 illustrates an array of angled transducers that is particularly suited for inspecting a pipeline.

FIG. 7 illustrates how additional transducers can be used to provide improved defect characterization.

FIGS. 8A and 8B illustrate a side view and bottom view respectively, of a magnetostrictive EMAT transducer that may be used for the transducer of the invention.

FIG. 9 illustrates a Lorentz force EMAT transducer that may be used for the transducer of the invention.

FIG. 10 illustrates an ultrasonic guided wave transducer carried by an inline inspection tool.

FIG. 11 illustrates an ultrasonic guided wave transducer implemented as a test device for use in testing pipeline welds from the exterior of the pipeline.

### DETAILED DESCRIPTION OF THE INVENTION

The following description is directed to an inspection tool having an arrangement of multiple ultrasonic guided wave transducers, such as EMATs (Electro Magnetic Acoustic Transducers). For both pipelines and plate structures, this transducer arrangement minimizes weld reflections while maintaining the ability to find flaws within welds.

For testing pipeline girth welds, the inspection tool is placed around the circumference of the pipeline. For other structures made from plate metal with welds, the inspection tool is placed against the exterior or interior of the plate metal, depending on which side is accessible.

More specifically, for pipelines, the transducers generate guided waves that use the pipe wall to act as a waveguide; the waves are guided by the inner and outer walls of the pipe. Multiple transducers work together to provide complete coverage of the structure. Data from multiple transducers may be combined together using array processing algorithms, such as synthetic aperture focusing technique (SAFT). The output of the processed data is an accurate measurement of the spatial location and extent of flaws in pipeline welds. For purposes of this description, in addition to pipelines that transport fluids, “pipelines” may include various tubing, such as used for heat exchangers.

For welds in plate structures, the waves are guided by the plate metal. Examples of plate structures for which this type of testing is useful are metal tanks and other large containment vessels.

For purposes of this description, the device used to transmit and receive guided waves is referred to as a “transducer” meaning that it is equipped to both generate and receive guided waves. These devices may also be referred to variously as a “transducer” or “sensor”, and it should be understood that a transducer is equivalent to a transmitter/receiver combination. Types of suitable transducers are discussed below. A “transducer” may be a single transducer or an array of small transducer elements that work together as a transducer.

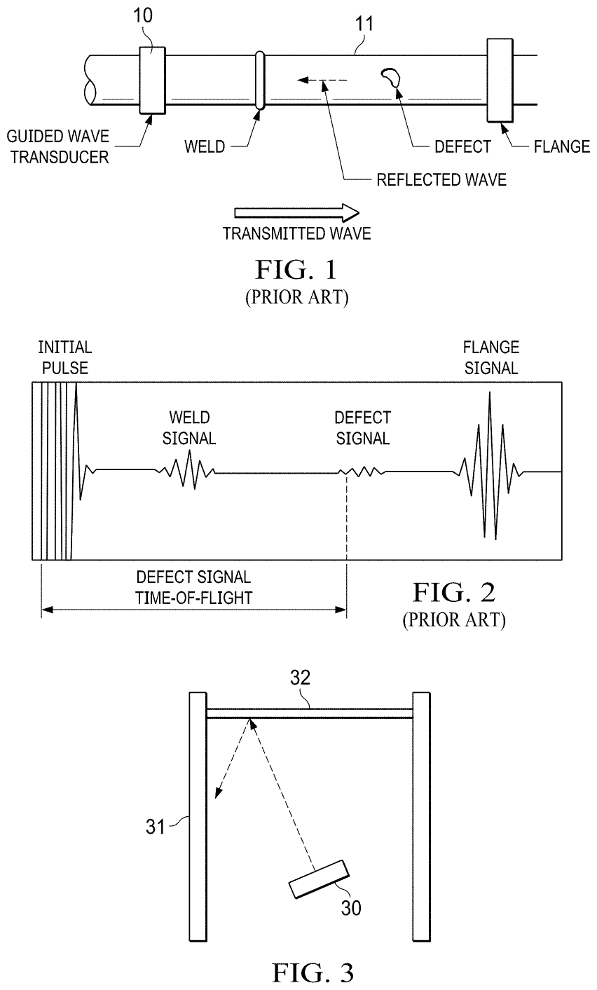

FIG. 1 illustrates a conventional guided wave transducer 10 being used to deliver guided waves along the walls of a pipeline 11 and to receive reflection signals. In a guided wave inspection system such as this, the inspection region is not under the transducer 10, but rather away from the transducer along the structure, which is pipeline 11 in this situation.

A pipeline weld, defect, and flange are also illustrated. The transducer 10 sends acoustic waves into the pipeline walls and listens for echoes. In a guided wave inspection system, the wavelength is on the order of or larger than the thickness of the walls of the pipeline or other structures, which allows the structure to guide the wave propagation along its walls.

As an example, a 16-inch gas transmission pipeline can allow guided waves to propagate a distance of 500 feet or more. Typical frequencies are in the range of 10 to 500 kHz.

Of significance to this invention is the fact that prior art transducers, such as transducer 10, are oriented such that the waves from transducer 10 propagate axially along the pipeline toward the welds. In other words, the wave direction of travel and the direction of the weld around the pipe are orthogonal to each other. This results in large reflection signals back from a weld, which masks defects close to or within the welds.

Although not explicitly shown in FIG. 1, for pipelines, transducer 10 has an array of transducer elements in a ring-shaped configuration. The transducer 10 is placed around the pipeline. Data is collected as the transducer scans along the pipeline. For plate structures, the transducer may be attached to the outer wall of the structure. Alternatively, transducer 10 may be a handheld device.

FIG. 2 illustrates the initial pulse and reflection signals from the weld, defect, and flange from the conventional system of FIG. 1. A change in the part geometry, such as a localized crack or corrosion region, generates a reflection that can be detected by the transducer 10. After detection of a reflection signal, position is estimated by time-of-flight calculations.

A feature of the invention is the recognition of problems associated with conventional ultrasonic guided wave transducers when they are attempted to be used for welds, especially pipeline welds. Conventional guided wave transducers are oriented to transmit ultrasonic waves in a direction orthogonal to the potential defect. However, when the ultrasonic wave is transmitted in a direction orthogonal to a weld, the weld itself creates a large reflection that is difficult to distinguish from other reflections due to defects in the weld. This reflection is primarily specular; the reflection occurs at the same angle to the surface normal as the incident beam but on the opposite side of the normal.

In the inspection tool described herein, the large weld reflection is avoided by arranging the transducers to transmit guided waves toward welds at an angle that is not orthogonal to the weld. The result is that the large reflection from the weld does not return to the transducer; it goes off at an angle such that the transducer does not detect it. Or, if the reflection signal is detected, it arrives outside an expected time window and can be ignored. However, a defect in the weld that is irregularly shaped or of a size small compared to the ultrasonic wavelength will generate diffuse reflection, so that some of the energy reflected by the defect will return to the transducer.

FIG. 3 illustrates the orientation of an ultrasonic guided wave transducer 30 for testing welds in accordance with the invention. In the example of FIG. 3, transducer 30 is being used to test a weld in a pipeline 31, but the same concept applies to welds in plate structures.

Transducer 30 is placed against the inner surface of the pipeline 31. The transducer 30 transmits ultrasonic waves which become guided waves along the pipeline walls. An inline inspection tool that carries an array of such transducers is described below.

However, unlike the transducer of FIG. 1, transducer 30 is placed at an angle (not orthogonal) to the welds or is otherwise designed so that the waves are not orthogonal to the welds. As a result, waves reflected by weld 32 are not reflected back to transducer 30. However, any flaws in the weld will reflect a signal back to transducer 30 because they are smaller than the acoustic wavelength.

The transducer orientation of FIG. 3 allows the test operator to detect defects within or near welds as well as within the bulk material of the pipeline.

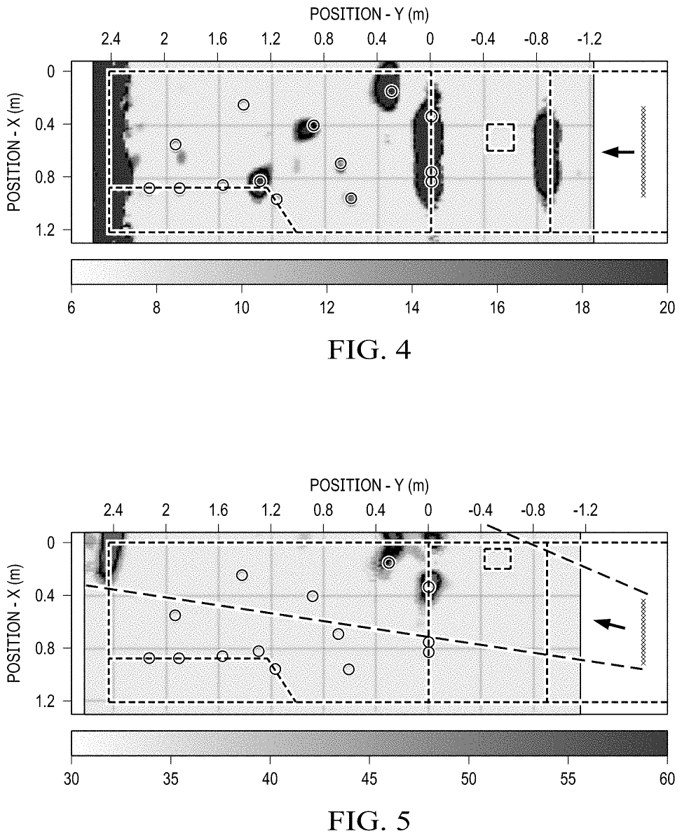

FIG. 4 illustrates an example of inspection results using the conventional inspection system of FIG. 1. In the example of FIG. 4, the transducer was oriented to deliver waves orthogonal to a weld in a plate. As illustrated, the weld response signal hides flaws near the weld. Similar results occur in the case of a pipeline with the waves delivered straight along the pipeline.

FIG. 5 illustrates inspection results for the same test sample as FIG. 4 but using the angled transducer 30 of FIG. 3. Rather than being delivered orthogonally to the weld, the waves are delivered at an angle to the weld. Because of this sensor orientation, the weld response signal is eliminated because the weld reflection does not return to the transducer 30. This allows reflections signals from defects to be detected.

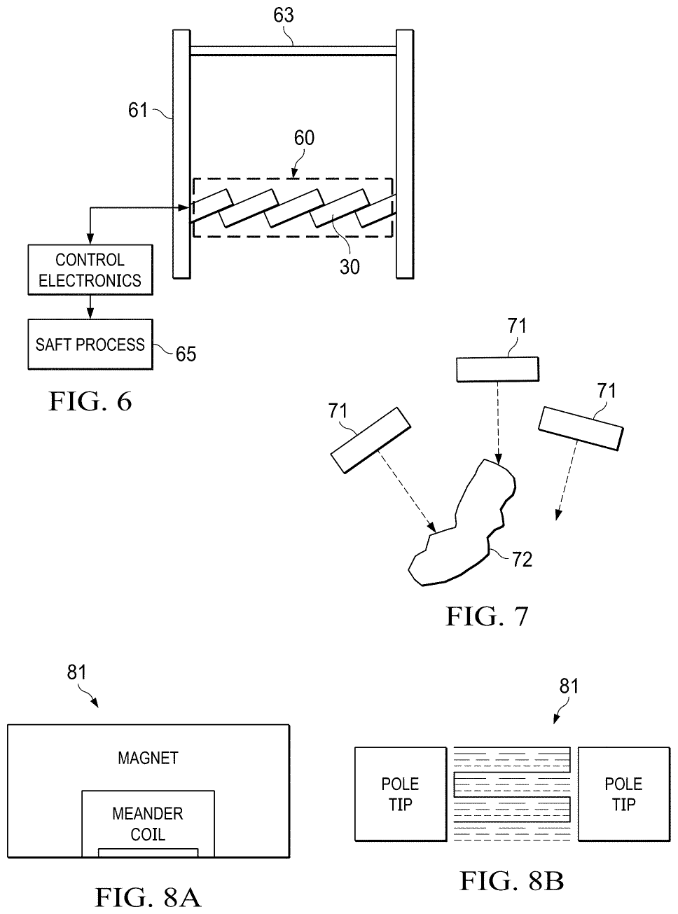

FIG. 6 illustrates an array 60 of angled transducers 30 that is particularly suited for inspecting a pipeline 61. The array comprises transducers 30 spaced around the circumference of the pipeline 61 so that the pipeline's entire circumference can be inspected. Each transducer 30 is angled relative to the pipeline welds 63 as described above.

In operation, the array 60 is carried by an inline inspection tool and acquires data as it is moving axially along the pipeline 61. The distance between data acquisition positions depends on factors such as the size of the transducers, strength and frequency of the transmitted waves, and pipeline material.

An enhancement of the array of FIG. 6 could provide at least one additional transducer 30, oriented to propagate orthogonally toward the weld. This transducer would be used to provide transducer-to-weld distance measurements.

FIG. 7 illustrates how additional transducers 71 can be used to provide improved defect characterization. In FIG. 7, various transducers 71 are oriented at different angles relative to a defect 72. The amplitude of the signal reflected from the defect is approximately proportional to the cross-sectional area of the beam interrupted by the defect. A non-circular defect will present different cross-sectional areas and hence different reflectivity depending on the beam angle. The results of different beam angles can be compared and used to determine defect orientation and surface extent. This assists in determining the effect of a defect on a pipeline's maximum allowable operating pressure.

Referring again to FIG. 6, once reflection data is collected, a SAFT process (or other array process) 65 can be used to combine the data and estimate defect locations. It is assumed that process 65 has appropriate hardware and programming for performing the tasks described herein. As described above, with additional transducers, defect location and characterization can also be estimated.

FIGS. 8A and 8B illustrate a side view and bottom view respectively, of a magnetostrictive EMAT transducer 81 that may be used for the transducer of the invention. Transducer 81 comprises a magnet 82 and coil 83. These sensors may be used with various wave modes for different applications. As examples, torsional waves may be used for pipes and tubes, and horizontally polarized shear waves for plates.

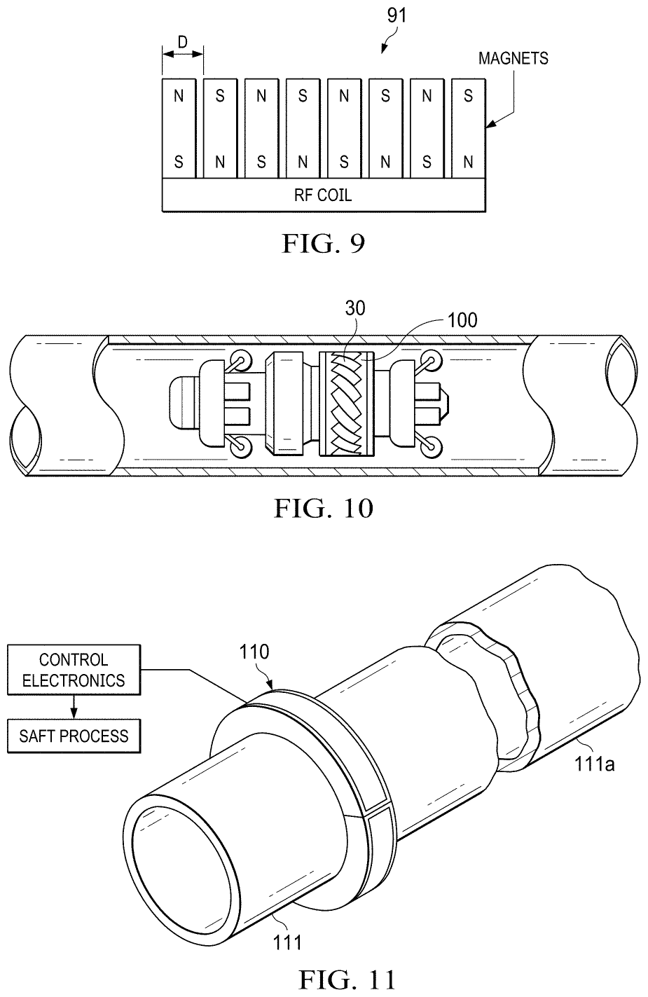

FIG. 9 illustrates a Lorentz force EMAT transducer 91 that may be used for the transducer of the invention.

An advantage of both transducers 81 and 91 is that they may be electronically phased to transmit waves toward or away from a weld. Both can be used to inspect the pipe base metal as well as its welds.

Test equipment incorporating both types of EMAT transducers 81 and 91, or other ultrasonic guided wave transducers, may vary depending on the type of structure being tested. Such devices may incorporate coupling material and appropriate electronics. For inspection from the outside of a structure, inspection devices may also have clamps (for pipelines), or suction cups, magnets or other attachment means (for plate structures).

FIG. 10 illustrates an ultrasonic guided wave transducer 100 carried by an inline inspection tool, commonly referred to as a “pig”. Transducer 100 has an array of transducer elements oriented at an angle to welds as described above. The tool travels axially along the inside of the pipeline 101, with transducer 100 collecting test data as it travels.

FIG. 11 illustrates an ultrasonic guided wave transducer 110 implemented as a test device for use in testing pipeline welds from the exterior of the pipeline. Transducer 110 has an array of transducers oriented at an angle to welds as described above. The device has an outer ring and clamp for securing the device to the pipeline 111 during testing. For purposes of the present invention, this device has an array of transducers, angled with respect to the pipeline welds 111a as described above.

In alterative embodiments, an ultrasonic guided wave transducer may be oriented at an angle to the weld and moved to different positions at the same distance from the weld. This embodiment simulates a large array of individual transducers.

1. A method of testing for defects in welds of a structure, such as a pipeline or plate structure, comprising:
placing one or more ultrasonic guided wave transducers against a wall of the structure;
wherein the one or more ultrasonic guided wave transducers are orientated such that guided waves from the one or more ultrasonic guided wave transducers are directed toward a weld at an angle to the weld;
delivering guided waves from the one or more ultrasonic guided wave transducers;
receiving reflection data from the one or more ultrasonic guided wave transducers;
processing the reflection data to indicate if a defect is present in the weld.

2. The method of claim 1, wherein the structure is a pipeline and the one or more ultrasonic guided wave transducers is a ring-shaped array of transducers.

3. The method of claim 1, wherein the structure is a pipeline and the placing step is performed by placing the one or more ultrasonic guided wave transducers against an inside wall of the pipeline.

4. The method of claim 3, wherein the one or more ultrasonic guided wave transducers is a single transducer, and further comprising moving the single transducer around the inner wall at a fixed distance from the weld.

5. The method of claim 1, wherein the structure is a pipeline and the placing step is performed by placing the one or more ultrasonic guided wave transducers against an outside wall of the pipeline.

6. The method of claim 2, wherein the one or more ultrasonic guided wave transducers is a single transducer and further comprising moving the single transducer around the outer wall at a fixed distance from the weld.

7. The method of claim 1, wherein the structure is a plate structure and the placing step is performed by placing the one or more ultrasonic guided wave transducers against an inside wall of the plate structure.

8. The method of claim 1, wherein the structure is a plate structure and the placing step is performed by placing the one or more ultrasonic guided wave transducers against an outer wall of the plate structure.

9. The method of claim 1, wherein the one or more ultrasonic guided wave transducers are EMATs (Electro Magnetic Acoustic Transducers).

10. The method of claim 1, wherein the processing step is performed with a synthetic aperture focusing technique (SAFT) process.

11. An improved ultrasonic guided wave inline testing device for testing for defects in welds of a pipeline, the improvement comprising:
a circular ring to which an array of ultrasonic guided wave transducers is attached;
wherein the ultrasonic guided wave transducers are orientated such that, when the inline testing device is placed within the pipeline, guided waves from the ultrasonic guided wave transducers are directed toward a weld at an angle to the weld.

12. The inline testing device of claim 11, wherein the ultrasonic guided wave transducers are EMATs (Electro Magnetic Acoustic Transducers).

13. The inline testing device of claim 11, wherein the ultrasonic guided wave transducers are magnetostrictive transducers.

14. The inline testing device of claim 11, wherein the ultrasonic guided wave transducers are Lorentz force transducers.
